(19) United States
(12) Patent Application Publication
(10) Pub. No.: US 2024/0327724 A1
(43) Pub. Date: Oct. 3, 2024

(54) SEPARATOR AND ASSOCIATED METHODS FOR PROCESSING GEL, OIL AND WATER MIXTURES

(71) Applicant: PERM Inc., Calgary (CA)

(72) Inventors: Mojtaba HASIRI, Calgary (CA); Apostolos KANTZAS, Calgary (CA)

(21) Appl. No.: 18/612,500

(22) Filed: Mar. 21, 2024

Related U.S. Application Data
(60) Provisional application No. 63/454,864, filed on Mar. 27, 2023.

(51) Int. Cl. C10G 33/02; B01D 15/36; B03C 1/01; B03C 1/28; B03C 1/30

(52) U.S. Cl. CPC C10G 33/02; B01D 15/362; B03C 1/01; B03C 1/28; B03C 1/30; B03C 2201/18; C10G 2300/1033

(57) ABSTRACT

A method of removing gel from a mixture is disclosed. The method includes receiving an initial mixture in a degradation vessel, the initial mixture comprising a polymer gel, oil and water from an underground formation. The initial mixture is processed within the degradation vessel with ultrasonic waves, wherein the ultrasonic waves degrade the polymer gel by breaking crosslinking bonds. Magnetic nanoparticles are then added to the resulting free polymer to form a magnetized mixture including agglomerated particles of magnetic nanoparticles bound to the free polymer. A magnetic field is then used to separate the agglomerated particles from the other components of the magnetized mixture.

### RELATED APPLICATION

This application claims 35 U.S.C. 119 priority to U.S. Provisional Patent Application No. 63/454,864 entitled “Separator and Associated Methods for Processing Gel, Oil and Water Mixtures”, which was filed on Mar. 27, 2023, and is hereby incorporated by reference in its entirety.

### BACKGROUND

The invention relates to processing and separating components of a gel, oil and water mixture extracted from an underground formation.

Polymer gels are elastomers with a three-dimensional (3D) network structure composed of polymers bound together with crosslinkers. The 3D network structure of polymer gel can bind a large number of solvents and make it resistant to high formation pressure. As a result, polymer gels may have adjustable strength and suitable deformability and pumpability, which makes them widely used in oil-gas engineering in applications such as formation plugging, lost circulation control, profile control, water shutoff, fracturing during production, and wellbore strengthening during oil-gas drilling (Lei, S. et al. “Types and Performances of Polymer Gels for Oil-Gas Drilling and Production: A Review”, Gels 2022, 8, 386).

In particular, gel injection is a very successful water control technology for heavy oil applications. The gels are used as water shutoff treatments to reduce the amount of water produced by the well relative to the amount of oil.

However, when certain chemicals, including polymer gels, are injected in a hydrocarbon bearing formation in enhanced oil recovery (EOR) projects, separation problems can occur. In particular, when low anionicity partially hydrolyzed polyacrylamide (HPAM), with chromium acetate or chromium chloride as the gelation crosslinker, is injected degraded gel particles or structures may be produced as part of the fluids recovered from the well. This is especially the case when the treatments are not successful.

Gel particles or structures coming up from the well (e.g., mixed with oil and water) can cause problems in the field separators and in the custody transfer from the oil producer to the pipeline. The gel particles and structures are difficult to manage in the processing facilities because they can plug off pump strainer nipples protecting pumps and water filtration, and they can disrupt oil-water separation in an oil treater (e.g. a horizontal treater) by adversely affecting the generation of the required coalescing layer within the oil treater at the oil-water interface.

Produced gels can even cause plugging issues at the inlet level controls on the free water knock out (FWKO-scuds) facilities. The problem arises because the gel particles have substantially the same density as the produced water, or lighter if some oil binds to them or if we use fresher water aid mixing. These polymer particles or structures are therefore typically suspended in the water phase.

Conventional bag filters typically plug off too quickly. That is, the presence of gel structures can accelerate the plugging of conventional bag filters. If larger bag filter sizing is used to mitigate this problem, the possibility of gel extruding through the holes increases as the bags deform with sustained applied pressure. This can result in the wells being shut in until a workable solution is figured out.

The typical process for dealing with free gel particles or structures is that the wells are produced to temporary tanks and all fluids are hauled to a disposal facility. In one example, a well was treated in 2018 at a cost of over $250,000 in tanks, trucking, disposal costs, well interventions, and facilities disruptions. A typical well producing 100 m³/day of fluid would generate significant ongoing costs. Many wells have a much higher production capability, in excess of 200-300 m³/day of fluid.

Conventional solids separation techniques such as those used for separating drill cuttings from drilling fluids cannot be used as the gels would block the screens. Additionally, conventional shaker systems are not enclosed to handle three phase production (oil, gas, and water). Gel shearing is also not believed to be a solution as smaller particles would then bypass existing surface controls and then plug the injection wells at the formation face limiting injection rates.

### SUMMARY

In accordance with the invention, there is provided a method of removing gel from a mixture, the method comprising:
receiving an initial mixture in a degradation vessel, the initial mixture comprising a produced fluid including a polymer gel, oil and water, the produced fluid having been produced from an underground formation;
forming a degraded mixture by sonicating the initial mixture within the degradation vessel with ultrasonic waves, wherein the ultrasonic waves break crosslinking bonds of the polymer gel to generate a free polymer;
adding magnetic nanoparticles to the generated free polymer to form a magnetized mixture comprising agglomerated particles of magnetic nanoparticles bound to the free polymer; and applying a magnetic field to the magnetized mixture to separate the agglomerated particles from the other components of the magnetized mixture.

The viscosity of the polymer gel at 25° C. and 1 atm may be at least 3,000 cps. The viscosity of the polymer gel at 25° C. and 1 atm may be at most 1,000,000 cps.

The polymer gel may comprise at least one of a nonflowing gel and a rigid gel (e.g. according to the Sydansk gel test described below).

The magnetic nanoparticles may comprise iron oxide.

The magnetic nanoparticles may comprise one or more of magnetite (Fe₃O₄) and maghemite (γ-Fe₂O₃).

The magnetic nanoparticles may be coated in a hydrophilic coating.

The magnetic nanoparticles may be coated in a metallic oxide.

The magnetic nanoparticles may be coated in one or more of: TiO₂, γ-Al₂O₃, MgO, ZrO₂ and NiO.

The ultrasonic waves may generate bubbles within the gel-oil-water mixture via ultrasonic cavitation.

The crosslinker may comprise metal ions.

Metal ions within the degraded mixture may be deactivated using a retarder.

Metal ions within the degraded mixture may be deactivated using sodium lactate.

Metal ions within the degraded mixture are removed using an ion exchange.

The initial mixture may comprise salt. The method may comprise adjusting (e.g., adding salt) the salt concentration of the initial mixture.

The gel may comprise hydrolyzed or partially hydrolyzed polyacrylamide.

The gel may comprise a polymer crosslinked with metal ions.

The gel may comprise a polymer crosslinked with chromium ions.

The method may comprise removing the crosslinker material (e.g. the metal or chromium crosslinker). The crosslinker may be removed using a resin (e.g., a cation-exchange resin such as amberlite® IR120). The resin may be added to the degraded mixture. The resin may be stirred with the degraded mixture The resin may be stirred with the degraded mixture for between 5-60 minutes. The degraded mixture may be stirred (e.g., for between 5-60 minutes) during and/or after sonication.

The agglomerated particles may be detached into magnetic nanoparticle and free polymer by adjusting the pH of the agglomerated particles to unbind the magnetic nanoparticles from the free polymer, and applying a magnetic field to separate the unbound magnetic nanoparticles from the free polymer.

Before the magnetic nanoparticles are added to the free polymer, the oil may be separated from the degraded mixture using a crossflow separator.

The initial mixture may be processed on a continuous basis.

The degradation vessel may have an internal volume with a circular cross-section and walls which are free to vibrate.

In the context of this disclosure, detaching components of a mixture may be taken to mean that the level of attraction between the two components is small, and so the components can be selectively controlled using external fields. For example, oil may be detached from oil and/or polymer to allow the oil to be controlled using a gravitational field. Or magnetic particles may be detached (or unbound) from a free polymer particle so that the magnetic particles can be controlled using a magnetic field independently from the free polymer particles. Detached components may still be physically in contact, and mixed on a macroscale, with other components of the mixture.

In the context of this disclosure, separating a component from a mixture means controlling the mixture such that the separated component is combined to form a unified volume of just that component. For example, after the sonication step, the oil may be detached from the polymer within the mixture (in that there is no significant bond between the two components), but the oil and polymer may each be distributed throughout the volume of the mixture. After detachment, the oil may be separated within a separator by allowing or promoting the oil to float to the top (using gravity and density differences) leaving the polymer and aqueous components of the mixture at the bottom. The oil forms a unified volume at the top of the separator and so would be considered separated from the remaining components of the mixture. The oil can then be removed from the separator into another vessel for storage or further processing.

The crosslinker may be a metallic ion. The crosslinker may comprise chromium. The crosslinker may comprise aluminum. The crosslinker may comprise iron. The crosslinker may comprise zirconium.

In the context of this disclosure, a free polymer is a polymer molecule which is not crosslinked to other polymer molecules.

The size of cavitation bubbles produced in an ultrasonic vessel may depend primarily on the ultrasonic frequency. The number of cavitation bubbles may depend on both the ultrasonic frequency and the ultrasonic power being introduced into the vessel. The pressure and viscosity of the liquid may also affect the number of cavitation bubbles.

The size of the bubbles produced during sonication may be between 2-50 microns.

The frequency of the ultrasound may be between 15 kHz and 30 KHz.

The ultrasonic energy supplied to the fluid may be at least 5 KJ/liter. The ultrasonic energy supplied to the fluid may be at most 50 KJ/liter. The ultrasonic power supplied to the fluid may be at least 1,000 W/liter. The ultrasonic power supplied to the fluid may be at most 10,000 W/liter.

The system may comprise one or more of: a viscosity sensor, a pressure sensor, a salinity sensor, and a flowrate or volume sensor. One or more of these sensors may be positioned in the inlet of the degradation vessel, in the degradation vessel, and/or in the outlet of the degradation vessel.

An electromagnetic field may be applied to the initial mixture during sonication. The electromagnetic field may have a frequency of between 10 Hz and 1 kHz.

The impact of salinity may depend on the specific retarder used, with sodium lactate and sodium malonate exhibiting differing demulsification durations.

The oil separation rates may be higher in samples treated with a resin for chromium removal. The oil separation rates may be influenced by the choice of retarder. In particular, using sodium malonate as a retarder resulted in a significant improvement in the oil separation rate compared to sodium lactate under various salinity conditions.

The effect of salinity on the demulsification process may be contingent on the specific type of retarder employed. In this context, sodium lactate and sodium malonate demonstrate distinct behavioural patterns.

Chromium (III) ions may play a crucial role in enhancing the stability of emulsions. The removal of these ions may significantly shortens the time required for demulsification. The rates of oil separation may be higher in samples that underwent treatment with resin for chromium removal. This parameter is also markedly influenced by the specific choice of retarder used in the process.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a is a schematic diagram a system showing flows and vessels used to carry out an embodiment of the separation method.

FIG. 1b is a flow chart showing the main steps of the process carried out using the system of FIG. 1a.

FIG. 2 is a graph of the degradation over time at different levels of salinity.

FIG. 3 is a grouped bar chart of the accumulated energy consumed to degrade 1 g gel under sonication at different levels of salinity and sonication times.

FIG. 4 is a grouped bar chart of the accumulated energy per mg of gel at different levels of salinity and HPAM solution concentration.

FIG. 5 is a graph of the gel remaining in a 2-minute sonication at different levels of salinity and HPAM solution concentration.

FIG. 6 is a graph giving a comparison of crude oil separation volumes for sodium lactate as retarder.

FIG. 7 is a graph giving a comparison of crude oil separation volumes for sodium malonate as retarder.

FIG. 8 is a graph giving the demulsification time as a function of NaCl concentration for samples containing 1000 and 2000 ppm HPAM aqueous solutions with and without chromium (III), and 400 ppm sodium lactate as retarder.

FIG. 9 is a graph giving the demulsification time as a function of NaCl concentration for samples containing 1000 and 2000 ppm HPAM aqueous solutions with and without chromium (III), and 400 ppm sodium malonate as retarder.

FIG. 10 is a graph giving the oil separation rates as a function of NaCl concentration (0-200,000 ppm) using 400 ppm sodium lactate as retarder.

FIG. 11 is a graph giving the oil separation rates as a function of NaCl concentration (0-200,000 ppm) using 400 ppm sodium malonate as retarder.

### DETAILED DESCRIPTION

### Introduction

The present technology relates to processing gel, oil and water mixtures. Such mixtures are typically produced by wells into which the gel has been injected to control various parameters of oil production. For example, gel may be injected into a well to seal off water producing fractures in order to increase the proportion of oil produced. The intention for gel-injection procedures is generally that the gel is injected into the well and will remain in place, but for various reasons, at least a portion of the injected gel may be recovered when the well is producing along with water and oil.

The present technology relates to separating the various components of the gel, oil, and water mixtures.

Typically, the issues which should be addressed when designing a method to separate gel, oil and water mixtures may include one or more of the following:
need to handle 3 phase fluids-gel, oil and aqueous polymer solution;
there is no significant density contrast between gel and water (thereby precluding the use of gravity, hydro-cyclone or centrifugal separation techniques);
significant volume of gel production (which precludes using filters as these would need to be changed too often);
Gel can deform, plug and extrude with pressure application to filtration media;
Re-gelation reactions may occur when crosslinker and polymer chains are still in the produced fluid and/or in the degraded mixture;
Polymer chains in the produced fluid reduce oil drop coalescence and make separation of oil from water difficult.

The process described herein has two major steps: a degradation step and a separation step.

The degradation step uses ultrasonic-cavitation-based technology to break out produced fluids, degrade gel structures, separate residual oil, remove heavy metals, and separate produced fluids of oil and water.

The separation step uses magnetic nanoparticles to bind to the free polymer which then allows the free polymer to be separated from the water component of the mixture.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Overview

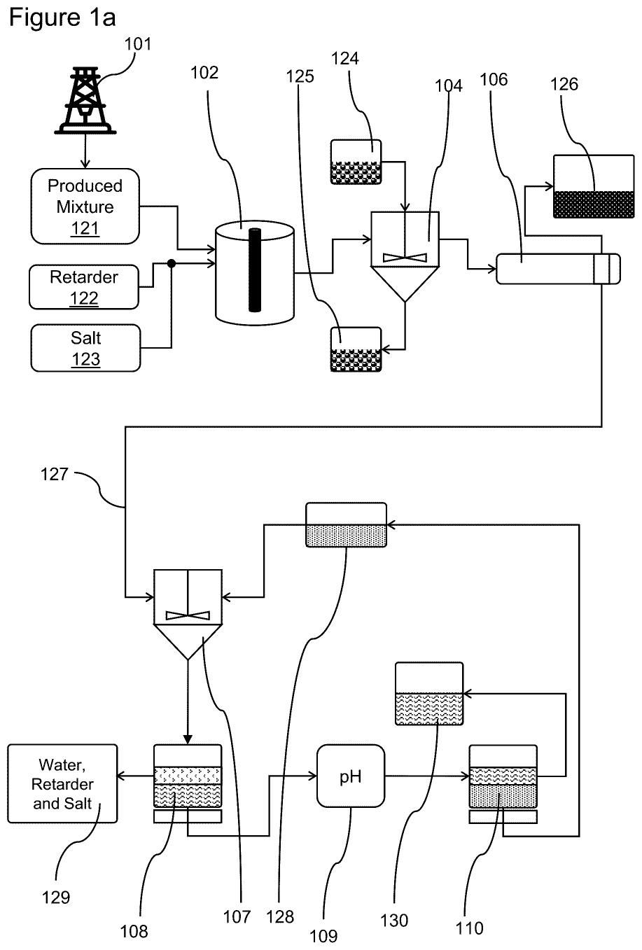

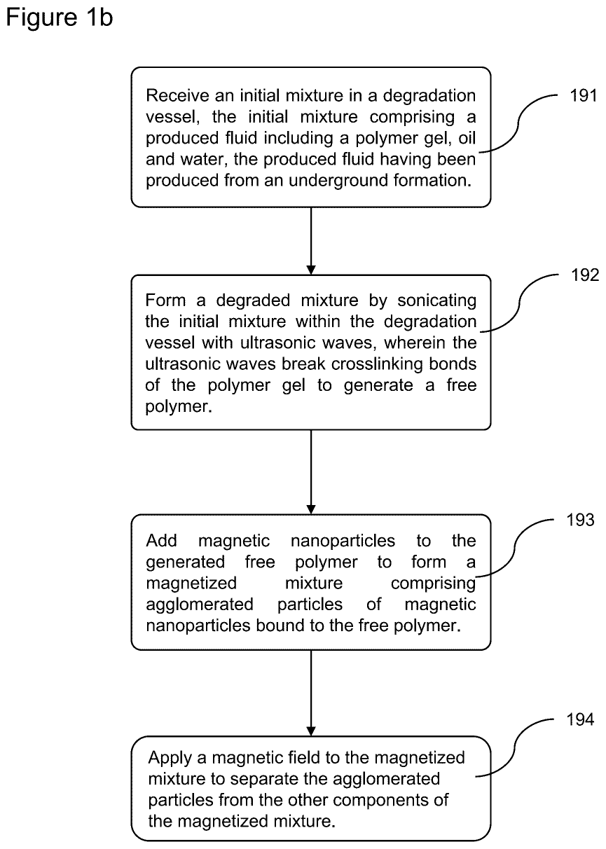

FIG. 1a shows a system for processing a gel, oil and water mixture received from a downhole source 101. The system is designed to degrade the gel and then to detach and separate the oil, polymer solution and degraded gel components. FIG. 1b is a flow chart showing the main steps of the process carried out using the system of FIG. 1a.

The produced mixture in this case is produced from a well using polymer flooding as an enhanced oil recovery method. Polymer flooding uses a flooding mixture of flooding polymer, water, and possibly some other additives, and is intended to increase oil recovery by decreasing the water-oil mobility ratio by increasing the viscosity of the displacing water. Because of this, the produced mixture includes oil, salt, gel particles (e.g., because of unsuccessful gel treatment), and polymer solution, which is an aqueous solution (because of the flooding polymer). The gel particle is degraded in a medium that contains polymer, water, and oil. The concentration of the polymer in water may affect degradation. Because of that, the effect of salinity and the flooding polymer concentration on degradation may be important.

In this embodiment, the degradation of the gel occurs in a degradation vessel which uses ultrasound on the initial mixture. Degradation, in this embodiment, involves removing the crosslinker material from the gel. The remaining free polymer are polymer chains which are no longer crosslinked to form a gel. Then the oil is separated from the resulting mixture, before the free polymer is detached from the water using magnetic nanoparticles.

As shown in FIG. 1b, the system of FIG. 1a is configured to:
receive 191 an initial mixture in a degradation vessel, the initial mixture comprising a produced fluid including a polymer gel, oil and water, the produced fluid having been produced from an underground formation;
form 192 a degraded mixture by sonicating the initial mixture within the degradation vessel with ultrasonic waves, wherein the ultrasonic waves break crosslinking bonds of the polymer gel to generate a free polymer;
add 193 magnetic nanoparticles to the generated free polymer to form a magnetized mixture comprising agglomerated particles of magnetic nanoparticles bound to the free polymer; and
apply 193 a magnetic field to the magnetized mixture to separate the agglomerated particles from the other components of the magnetized mixture.

### Ultrasonic Degradation

In this embodiment of the system, the first step is degrading of the gel in a degradation vessel 102.

The produced mixture 121, which includes oil, water and gel particles (and possibly polymer molecules) and is produced from the downhole formation 101, is injected into the degradation vessel 102. In this case, the gel comprises particles of partially hydrolyzed polyacrylamide (HPAM) crosslinked by Cr⁺³. In this example, the gel is a nonflowing or rigid gel.

In this embodiment, salt 123 and retarder 122 are also added to the degradation vessel, with the produced mixture, to form the initial mixture. The retarder is added to ensure that, when the polymer gel is degraded into the constituent components of free polymer and crosslinker, the components do not recombine to form a crosslinked polymer gel again. The retarder may comprise one or more of: sodium L-lactate; disodium malonate and sodium hypochlorite.

The salt is used to control how the ultrasonic waves interact with the fluid within the degradation vessel. The inventors have discovered that there is an optimal salt concentration which improves the time and energy required to degrade the gel. See the Experimental section below for more details. In this embodiment, the concentration of salt (in this case NaCl) within the degradation chamber is between 50,000 mg/l and 200,000 mg/l.

In this embodiment, the gel particles are first degraded by sonication in the ultrasonic tank. Sonication takes place for each batch over between 5-20 minutes at a frequency of between 15 and 30 KHz. The sonication breaks the crosslinks and results in the polymer gel detaching into its free polymer and crosslinker components. The sonication may facilitate this reaction through a combination of one or more of: cavitation, heat energy, and hydroxyl radicals (·HO).

Ultrasonic cavitation is the process of vaporizing liquid by rapidly decreasing and increasing localized pressure in a fluid flow system below the fluid vapor pressure, resulting in large numbers of tiny bubbles. As those bubbles collapse, very high localized temperatures, pressures, and shock waves are created. This high level of energy release degrades polymer gel structures.

Using ultrasonic cavitation has been found to produce consistent results without the use of a heater treatment system.

The ultrasonic cavitation is configured to physically and chemically break the weak and strong bonding mechanisms that keep oil and water from detaching completely and quickly, as well as the bonds between crosslinker and polymers in gel networks.

To prevent the crosslinkers and polymers from recombining into a gel, the retarder deactivates the chromium (III) crosslinkers.

Ultrasonic waves have been found to be a dependable, environmentally friendly, and cost-effective method of degrading the polymer gel. The system (or production engineer) can then check the real-time effect and further optimize the results of various acoustic parameters (e.g., amplitude, power and frequency) and sonication times. For example, the system may automatically monitor the one or more of: viscosity, pressure, salinity, and flowrate or volume of the output (and optionally also at the input for comparison) and adjust the acoustic parameters accordingly.

By measuring the viscosity of the fluid before and after sonication (e.g. at the inlet and outlet), it is possible to determine the extent of degradation and adjust the acoustic parameters (e.g., amplitude, power, and frequency) and sonication time accordingly. Additionally, the use of process control systems and sensors can help automate the process and ensure consistent and reproducible results.

### Structure of Degradation Vessel

In this case, the degradation vessel is a cylindrical vessel with an elongate ultrasonic actuator mounted axially along the cylinder axis. The elongate actuator is configured to vibrate at frequencies of between 15 kHz and 30 KHz.

Using a cylinder helps reflect the ultrasonic waves back into the body of the vessel. In this case, the cylindrical wall of the degradation vessel is a double wall where there is a gap between an inner and outer wall. This allows the inner wall to vibrate freely which helps reflect ultrasonic waves back into the body of the vessel.

Other features that that may be used to improve the effect of ultrasound in a Helmholtz vessel may include one or more of the following:
Resonant Frequency: The resonant frequency of the Helmholtz vessel is designed to match the frequency of the ultrasonic waves being generated, which helps to maximize the energy transfer between the waves and the fluid.
Shape and Size: The size and shape of the Helmholtz vessel can impact the intensity of the ultrasonic waves. A larger vessel will typically have a lower resonant frequency and a smaller vessel will have a higher resonant frequency.
Material Properties: The choice of material used for the inner wall of the Helmholtz vessel is important as it affects the damping and resonance properties of the wall. Typically, materials with low damping and high resonant frequencies are used to improve the efficiency of the ultrasound.
Acoustic Coupling: A medium is often used to acoustically couple the ultrasonic transducer to the fluid in the Helmholtz vessel. This can improve the transfer of energy between the transducer and the fluid, and reduce reflections and losses.
Damping: Damping materials can be used on the inner wall of the Helmholtz vessel to reduce unwanted resonances and improve the overall efficiency of the ultrasound.
Waveform: The waveform of the ultrasonic energy can also impact the efficiency of the ultrasound. Some waveforms are better suited for specific applications and can be optimized to improve the efficiency of the ultrasound in the Helmholtz vessel.

These features allow the degradation vessel to act as a Helmholtz resonator which improves the intensity of the ultrasonic waves within the vessel.

### Initial Separation Steps

After the initial mixture has been degraded, the resulting degraded mixture, in this example, comprises oil, water, free polymer, crosslinker, salt and retarder. This degraded mixture is transferred to a crosslink separator 104. The crosslink separator, in this case comprises a mixer (or stirrer) which receives the degraded mixture and cation-exchange resins 124.

The crosslinker in this case is chromium (III) ions. Chromium (III) and most heavy metals may be removed by cation-exchange resins. The cation-exchange resin surfaces are hydrophilic, so the oil droplets do not attach to them. The chromium (III) crosslinkers selectively bind to the resin which is then removed at the bottom of the crosslink separator. In this case, the exchange resin comprises Amberlite™ IRC-120 (H) beads (e.g., with a harmonic mean diameter of 0.62-0.83 mm).

The exchange resin may be added after ultrasonic degradation to remove the chromium (III) ions.

After the resin-crosslinker combination 125 has been separated from the liquid, the resins are regenerated by adjusting the pH. Using resin to separate the chromium (III) crosslinker is an optional step which is particularly useful when there are a large number of gel structures or when heavy metals need to be removed before entering a separator or other facility.

The rest of the degraded liquid is then passed to an oil separator 106. It will be appreciated that the degraded mixture may comprise micro-emulsions of oil and water. These micro-emulsions can be generated downhole.

Micro-emulsions can be difficult to break by traditional separation means. Heat and expensive chemicals provide a partial solution, but residual oil carryover still sends valuable oil to the water injection well, resulting in lost efficiency, production, and profits.

In this embodiment, a crossflow oil separator 106 is used to separate the oil from the liquids with the same density as water.

The crossflow separator, in this case, comprises a vessel in which fluid is injected at one end and removed from the other end. Flow within the vessel is generally horizontally between the inlet and the outlet. Between the inlet and outlet are a series of baffles or plates which the fluid flow must pass around. These plates disrupt the flow and allow droplets of similar materials to coalesce. As the coalesced droplets are larger, the differences in density (e.g., between oil and water) allow the coalesced droplets to separate in a generally vertical direction, with the lighter fluids (e.g., oil) floating towards the top, and the denser fluids (e.g., water) remaining at or sinking towards the bottom. The lighter fluids can then be separated from the mixture at the top of the crossflow separator, and the denser fluids can be separated from the mixture at the bottom of the crossflow separator. In this way, the oil 126 is separated and recovered from the initial mixture.

In this embodiment, the coalescence plates are made of a series of trapezoidal polypropylene plates that are cross-placed with each other. The materials of the coalescence plates are made of hydrophobic material (e.g., polypropylene), which help the oil droplets adhere to the surface of the plates and coalesce. This reduces the time for the separation of oil from the other liquids.

Using coalescence plates also helps retrieve residual oil, which can increase both oil recovery and the bottom line. As mentioned, residual crude in produced water can be as high as 1%. Many facilities process thousands of barrels of produced water per day, particularly in fields that have a high water cut. Residual oil carryover becomes a significant volume.

### Separating Free Polymer

At this point for this embodiment, the crosslinker and oil 126 have each been separated and removed from the initial mixture 121, and an aqueous mixture 127 remains which includes free polymer and water. As noted above, the free polymer may have a density similar to that of water.

In the polymer separation step, the free polymers (HPAM in this case) are removed from the solution by using magnetic nanoparticles. This involves adding magnetic nanoparticles 128 to the aqueous mixture 127 and mixing the nanoparticles with the aqueous mixture in a mixer 107 to form a magnetized mixture.

The mixing allows the magnetic nanoparticles to bind to the free polymer forming agglomerated particles of magnetic nanoparticles bound to the free polymer. The magnetic nanoparticles may be functionalised to facilitate binding with the free polymer. The magnetic nanoparticles may be amine-functionalized magnetic nanoparticles. It will be appreciated that the agglomerated particles are magnetic by virtue of comprising the magnetic nanoparticles.

Applying a magnetic field to the magnetized mixture comprising water and magnetic agglomerated particles within a magnetic separator 108 causes the magnetic agglomerated particles to separate from the aqueous phase 129, which in this case includes water, retarder and salt.

In this case, the magnetic field attracts the agglomerated particles to the bottom of the magnetic separator where there is an outlet to allow the agglomerated particles to be removed from vessel. Similarly, there is another outlet at a higher level within the magnetic separator vessel which allows the aqueous phase 129 to be drawn off and removed.

In this case, the magnetic nanoparticles comprise iron oxide coated with a metallic oxide coating. The metallic oxide coating is hydrophilic which helps prevent the magnetic nanoparticles from binding to any hydrocarbons present (e.g., residual oil), and to preferentially bind with the free polymers. The coating is typically functionalized with amines to allow the magnetic nanoparticles to bind better with the free polymer. The magnetic nanoparticles in this embodiment have a Dv90 diameter of less than 1 μm. The magnetic nanoparticles in this embodiment have a Dv10 diameter of greater than 10 nm.

The magnetized agglomerated particles are then mixed with a fluid to adjust the pH in a pH adjusting vessel 109, which allows the magnetic nanoparticles to unbind and/or detach from the free polymer.

In another magnetic separator 110, a magnetic field is applied which selectively influences the unbound magnetic nanoparticles which can then be separated and recycled. In this case, the magnetic field attracts the unbound magnetic nanoparticles to the bottom of the magnetic separator vessel where they can be extracted via an outlet towards the bottom. Another outlet higher up the magnetic separator vessel allows the unagglomerated free polymer 130 to be removed and separated from the magnetic separator. The separated free polymer may be recycled by combining with the separated crosslinker for reform a gel. In some embodiments, the pH adjustment may take place in the second magnetic separator 110. Likewise, the magnetic nanoparticles 128 may also be recycled.

The use of magnetic nanoparticles (MNPs) to remove contaminants from produced water is an environmentally friendly method of treating produced water that uses few chemicals. The main attraction of MNPs is their quick response to moving in a desired direction when an external magnetic field is applied. Another advantage of MNPs is the ability to modify their surfaces in a variety of ways, depending on the characteristics of the target contaminants. The removal efficiency of HPAM from water with MNPs is affected by the type and concentration of brines, the concentration of amine-functionalized MNPs, the surface coating of the MNPs, the molecular weight of the polymer, and the number of times the MNPs are regenerated and reused. Using MNPs reduces chemical agent costs, corrosion risk, water treatment process time, and maintenance costs.

Produced emulsified fluids with gel particles from existing wells are transported more than once to self-operated and/or third-party oil/water separation and disposal facilities, resulting in excessive trucking costs. Operating cost reductions can be realized by treating produced fluids on site with this method eliminating excess trucking.

### Other Options

The technology may be used in polymer flooding, well gels treatment, and/or water treatment.

The degradation vessel may be designed like a Helmholtz resonator. Ultrasonic resonance may increase the performance of ultrasonic system.

The efficiency of the system may be increased by using electromagnetic (EM) radiation instead of, or as well as, sonication.

Adding resin recycling unit. In this step, cation-exchange resin could be reused by adjusting the pH and chromium (III) could be recycled to reuse for gel treatment.

In the embodiment of FIG. 1a, the degradation vessel can be used for batch processing. This involves filling the degradation vessel with the initial mixture (with additives such as salt and retarder) and sonicating the fluid for a period of time before passing the degraded mixture to later steps in the process (e.g., the various separation steps).

In other embodiments, the system may be run in a continuous mode. In this case, the degradation vessel may be an elongate vessel where flow is generally along the elongate axis of the vessel. As the initial mixture passes though the elongate degradation vessel, the initial mixture would be sonicated for a period of time. This would result in the proportion of degraded mixture would increase as a function of distance between the inlet and outlet of the degradation vessel. This would allow the system to operate in a continuous mode.

The void rate in cavitation refers to the amount of void or bubble formation that occurs in a fluid as a result of cavitation. It is possible to use an electromagnetic field to influence the void rate in cavitation, but the exact effect would depend on the specific details of the system and the strength of the field. Cavitation can be influenced by changes in the fluid's pressure, and an electromagnetic field could potentially alter the pressure distribution in a fluid, thus affecting the void rate. However, the magnitude of this effect would likely depend on the strength and orientation of the field, as well as the fluid's properties and the geometry of the system. In some cases, an electromagnetic field might increase the void rate by further reducing the fluid pressure and promoting cavitation. However, in other cases, the electromagnetic field might stabilise the fluid and reduce the likelihood of cavitation. It's important to note that the use of an electromagnetic field to control cavitation is still an active research area, and much more study is needed to fully understand the effects of electromagnetic fields on cavitation and the void rate.

During sonication, an electromagnetic field may be used to influence the sonication. In the context of combining ultrasonic and electromagnetic fields to enhance cavitation, the type of electromagnetic (EM) radiation that is typically used is low-frequency electromagnetic fields, such as alternating current (AC) electromagnetic fields (e.g. between 10 Hz and 1 kHz).

These fields can influence the fluid pressure distribution and alter the fluid velocity, which can affect the formation and stability of cavitation bubbles. For example, low-frequency AC electromagnetic fields can create eddy currents in the fluid, which can generate secondary fluid flows that can promote or stabilize cavitation.

The strength and orientation of the electromagnetic field, as well as the frequency and intensity of the ultrasonic waves, would need to be carefully chosen and controlled in order to achieve the desired effect on the cavitation. The specific details of the system, such as the fluid properties and the geometry of the components, would also play a role in determining the optimal conditions for enhancing cavitation with a combination of ultrasonic and electromagnetic fields.

It's worth noting that the use of electromagnetic fields for enhancing cavitation is still an area of active research, and much more study is needed to fully understand the mechanisms by which these fields can affect cavitation and to optimize the combination of ultrasonic and electromagnetic fields for specific applications.

### EXPERIMENTAL

The inventors carried out a series of experiments in relation to the degradation step. In particular, the inventors studied the impact of ultrasonic waves on the degradation of partially hydrolysed polyacrylamide (HPAM) gel structures, focusing on the effects of sonication time, NaCl concentration, and HPAM solution concentration.

For these experiments, two different types of partially hydrolyzed polyacrylamide (HPAM) polymers with varying molecular weights were used. FLODRILL™ TS-055 LT (MaraSeal™), which possesses a low anionic charge and a low molecular weight. FLORET™ AN 907 PG (Marcit™), which also has a low anionic charge but a medium molecular weight. Both were sourced from SNF Holding Company (USA). Chromium (III) acetate solution, containing chromium (III) content of 11.5-12.5% by weight was used as a crosslinker solution and was obtained from McGean Chemical Company (USA). Analytically pure sodium chloride (NaCl) was used to prepare brine. Deionized water (DIW) was used to prepare aqueous solutions. The crude oil used in this study was a medium-viscosity oil sourced from southeastern Alberta. An ultrasonic generator, (Qsonica™, USA), was used to degrade polymer gel particles mixed with oil/water/polymer mixtures that were received from a produced well in the field.

The HPAM gelant sample was prepared using HPAM commercial solution, FLORET AN 907 PG (Marcit) with a concentration of 8000 ppm by mass and chromium (III) acetate as a crosslinker. All substances were mixed on a weight basis and were used without any extra purification. The amount of Marcit powder needed to reach 8000 ppm was dissolved in deionized water (DIW) and stirred for 8 hours to make sure that all of the polymer was dissolved. Afterwards, a pipette was used to carefully add chromium (III) acetate solution, with a chromium content of 11.5-12.5%, to the HPAM solutions. After a specific concentration of Cr³⁺ solution had been added, 55 μL of ˜12% Cr³⁺ crosslinker solution was added to a 50 g polymer sample. The HPAM gelant sample was placed in an oven at 60° C. for 10 days.

In this study, crude oil was added to polymer solutions with varying polymer concentrations to achieve a water-to-oil ratio (WOR) of 19 by volume and the mixture was agitated using ultrasonic waves to disperse the oil droplets into the polymer solution, using FLODRILL TS-055 LT (MaraSeal) with different polymer concentrations. The temperature of the sample was measured initially, and only one-third of the ultrasonic probe was immersed in the sample solution. Then, approximately 1 g of HPAM gel structure was mixed with 100 mL of the oil/water/polymer mixture. The samples were then subjected to ultrasonic waves at a constant frequency of 20 KHz and a power of 500 Watts for 2-14 minutes. A cold-water bath was used to keep the temperature of the solution constant during sonication.

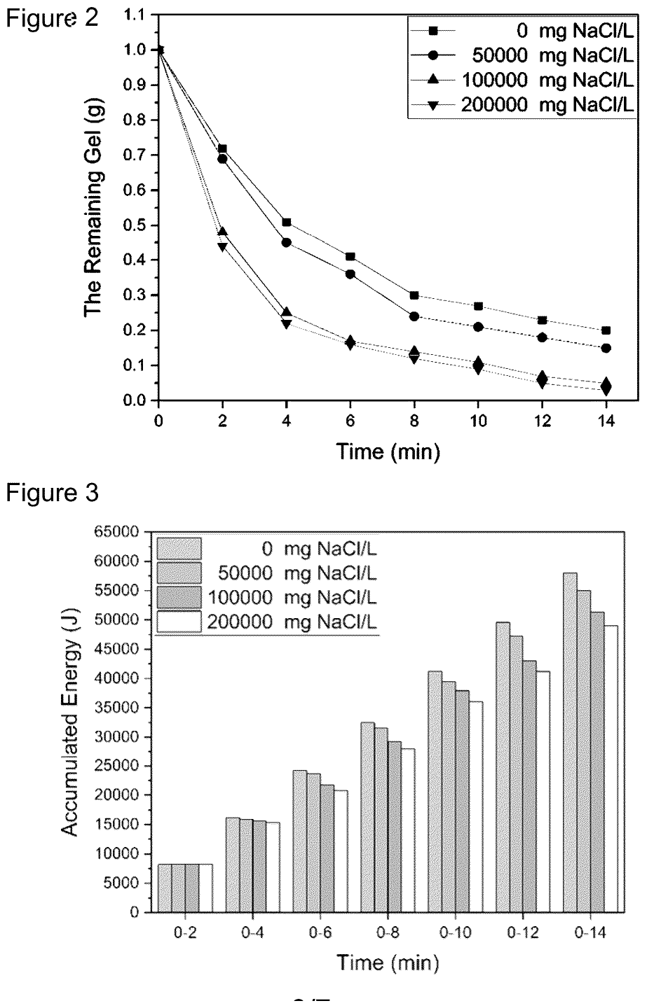

FIG. 2 is a graph of the degradation over time of 1 g gel under sonication at a frequency of 20 KHz and 500 W power, using HPAM solution with a constant concentration of 2000 ppm by mass and at different levels of salinity (0-200,000 mg NaCl/L). During sonication, which was the same for both experiments, the quantity of gel (i.e., crosslinked undegraded gel) was monitored. The quantity of gel was monitored by the following procedure: after sonication, the remaining mixtures were filtered through filter papers with 25 micrometer pores and washed with deionized water and toluene to remove any remaining oil and polymer from the filter. After drying the filter sheets in an oven at 70 degrees Celsius for 45 minutes, the remaining gel structures were measured and recorded.

As shown in FIG. 2, the gel degrades more rapidly in the presence of salt. The results also indicate that across the range of brine concentrations used (including no salt), an 8-minute sonication effort resulted in significantly degraded HPAM gel structures, with more than 0.7 g out of 1 g of the sample degraded. However, continuing sonication beyond 8 minutes resulted in limited further degradation, with less than 0.15 g of the gel being broken down as compared to at the 8-minute mark, and the degradation rate after 8 minutes is almost constant.

This may be due to the effect of electrolytes (NaCl) on degelation rates and may be explained by the effect of molecular chain contraction. Increasing brine salinity may cause polymer chains to contract. The shrinking of the chain is a direct result of the ability of sodium ions to block the repelling electrostatic interactions between the negatively charged acrylate groups in the polymer chain.

FIG. 3 is a graph of the accumulated energy consumed to degrade 1 g gel under sonication at a frequency of 20 KHz and 500 W power, using HPAM solution with a constant concentration of 2000 ppm, and at different levels of salinity and sonication times. In each group of bars, the left bar corresponds to 0 mg NaCl/L, the second bar from the left corresponds to 50,000 mg NaCl/L, the third bar from the left corresponds to 100,000 mg NaCl/L, and the right bar corresponds to 200,000 mg NaCl/L.

As seen in the FIG. 3, the sample with a salinity of 50,000 mg NaCl/L exhibits significantly higher accumulated energy after 14 minutes of sonication compared to the sample with a salinity of 200,000 mg NaCl/L. It is observed that the accumulated energy remains consistent across the four salt concentrations until four minutes of sonication. However, as the sonication time increases beyond 4 minutes, there is a decrease in accumulated energy with an increase in salinity. This decrease in accumulated energy is less marked at higher salinity levels, for example when the salinity increases from 100,000 mg NaCl/L to 200,000 mg NaCl/L. This implies that there is an optimal point for increasing salinity, which must be considered in relation to other factors such as corrosion risk.

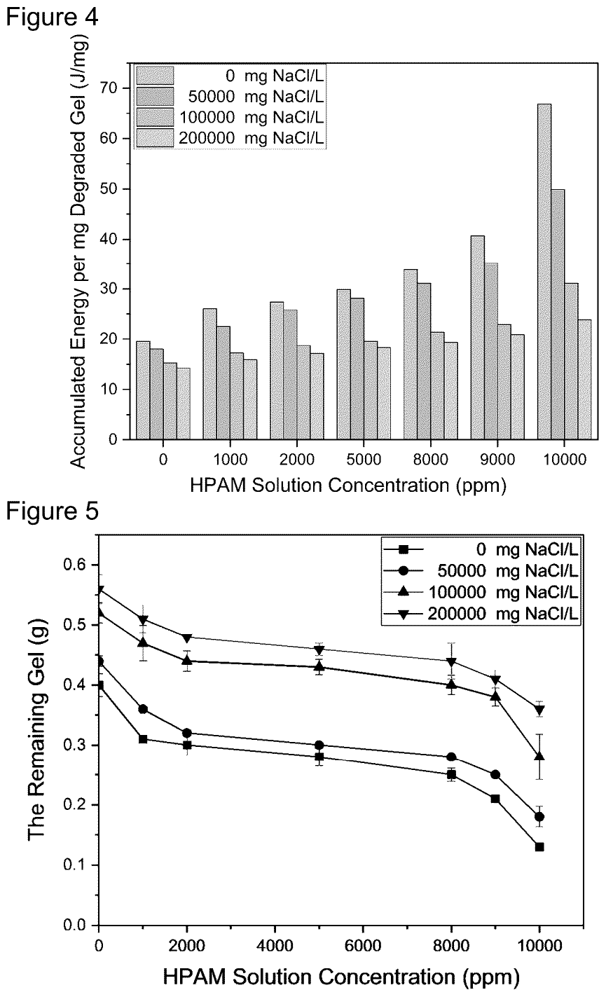

FIG. 4 is a graph of the accumulated energy per mg of gel at 2-minute sonication at 20 KHz and 500 W, with initially 1 g of gel particle, and different levels of salinity and HPAM solution concentration. In each group of bars, the left bar corresponds to 0 mg NaCl/L, the second bar from the left corresponds to 50,000 mg NaCl/L, the third bar from the left corresponds to 100,000 mg NaCl/L, and the right bar corresponds to 200,000 mg NaCl/L.

The data presented in FIG. 4 illustrates that as salinity increases, the amount of energy required to degrade 1 mg of gel particles decreases considerably for each polymer solution concentration. Additionally, when no salt is present, increasing in polymer solution concentration results in a significant increase in the energy required to degrade 1 mg of gel.

However, as salinity increases, the sensitivity of energy required for degrading 1 mg of gel to polymer concentration decreases. Specifically, when the polymer solution concentration is increased from 0 to 10000 ppm, the accumulated energy required for degradation increases from 14.22 to 23.79 J/mg for a mixture with 200000 mg NaCl/L. In contrast, when the polymer solution concentration is increased from 0 to 10000 ppm, for a mixture without salt (0 mg NaCl/L), the accumulated energy increases from 19.54 to 66.86 J/mg. These data suggests that the presence of salt has a mitigating effect on the energy required for gel degradation as polymer concentration increases.

FIG. 5 is a graph of the gel remaining in a 2-minute sonication at 20 KHz and 500 W, initially 1 g of gel particle, and different levels of salinity and HPAM solution concentration. FIG. 5 shows that an increase in polymer solution concentration generally leads to a decrease in gel degradation, both in the absence and presence of NaCl.

These experiments indicate that:
both sonication time and salinity levels play an important role in the degradation of HPAM gel. As sonication time increases, the remaining gel decreases, with 70% of gel particles degraded by 8 minutes of sonication across all conditions explored in these experiments.
the gel degrades at a faster rate in the presence of higher levels of salinity.
As sonication time increases, more energy per mg is required to degrade the gel particles.
Increasing salinity reduces the energy required to degrade the gel, but diminishing returns are shown at higher salinity levels. This implies that there is an optimal point for increasing salinity.
An increase in polymer solution concentration generally leads to a decrease in gel degradation, both in the absence and presence of salt.
As salinity increases, the amount of energy required to degrade 1 mg of gel particles decreases considerably for each polymer solution concentration tested.
The presence of salt has a mitigating effect on the energy required for gel degradation as polymer concentration increases.

### Further Experiments

The experimental methodology comprised two major steps: the preparation of the Marcit gel and suspension of oil-MaraSeal solution, and the experimental procedure for testing how the gel and solution would be processed.

An HPAM gelant sample was prepared using a commercial Marcit solution with a concentration of 8000 ppm and chromium (III) acetate as a cross-linker. The commercial solution was prepared by dissolving the required amount of Marcit powder to reach 8000 ppm in deionized water (DIW) and it was stirred for 8 h to ensure that the polymer dissolved completely. A 50 g polymer sample was then mixed with 55 μL of ˜12% Cr³⁺ cross-linker solution, in the form of chromium acetate solution containing ˜12% Cr³⁺. The resulting mixture was placed in an oven at 60° C. for 10 days to form the HPAM gelant sample. No further purification was performed. Simultaneously, a suspension that mimicked the properties of a well-produced fluid was created by dispersing crude oil into the MaraSeal solution via sonication and maintaining a water-oil ratio (WOR) of 19 by volume. This was prepared following a standard protocol for preparing oil-water suspensions.

For the experimental procedure, initially, 100 mL of an oil-MaraSeal solution suspension was transferred into a beaker. Subsequently, 1 g of cross-linked Marcit gel structure with chromium (III) was added to the suspension. One-third of the ultrasonic probe was then immersed in the suspension, and prior to sonication, a 0.04 g of retarder was added to the suspension to prolong the potential regelation reaction. In this study, the weight of retarders used were calculated to reach 160 times excess of the stoichiometric reaction calculation. The beaker was subjected to ultrasonic waves at a constant frequency of 20 kHz and a power of 700 Watts for 15 min to fully degrade the gel particles.

After ultrasonic degradation, 1 g of Amberlite® IR120 resin was added to the suspension to remove Cr³⁺ ions from the degraded fluid, and the mixture was stirred for 10 min. The resin and separated oil on surface of emulsion were then separated from the mixture. The volume of oil separated during stirring was measured and recorded. Afterwards, the remaining emulsion was placed in an oven at 70° C. for 30 days to separate the oil from the emulsion. During these 30 days, the volume of the separated oil was monitored and demulsification time was determined. After 30 days, the separated oil collected from the top and the solution from the bottom were measured.

The oil separation rate for stirring section (Vs) is considered as the volume of separated oil per stirring time and the oil separation rate for demulsification section (Vdm), is considered as the volume of oil separated after demulsification per time of emulsion break. The total oil separation rate (V) is deemed as the sum of the oil separation rate in the stirring section (Vs) and that in the demulsification section (Vdm).

In these experiments, crude oil separation was investigated during stirring section (chromium (III) removal unit), demulsifiction section, and also both sections together as a separation unit.

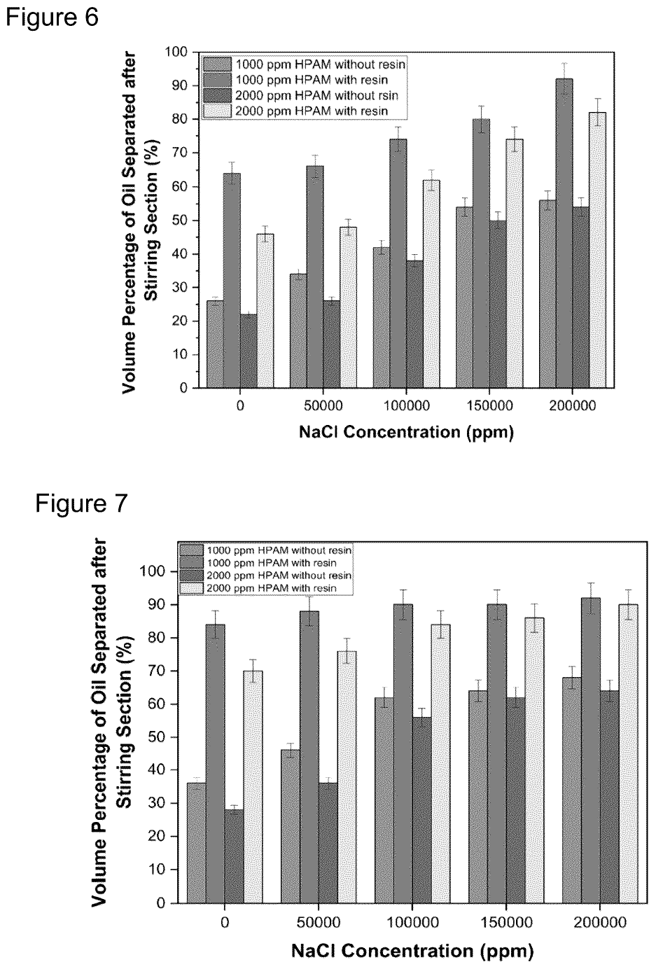

FIG. 6 is a graph giving a comparison of crude oil separation volumes for sodium lactate as retarder, the concentration of retarder is 400 ppm, at different salinity levels (0, 50,000, 100,000, 150,000, and 200,000 ppm NaCl) and hydrolyzed polyacrylamide solution concentrations (1000 and 2000 ppm), with and without chromium (III) presence. The presence of chromium (III) is controlled using resin configured to remove the chromium (III). In each group, the left bar corresponds to 1000 ppm HPAM without resin, the next bar corresponds to 1000 ppm HPAM with resin, the next bar corresponds to 2000 ppm HPAM without resin, and the right bar corresponds to 2000 ppm HPAM with resin.

FIG. 7 is a graph giving a comparison of crude oil separation volumes for sodium malonate as retarder, the concentration of retarder is 400 ppm, at different salinity levels (0, 50,000, 100,000, 150,000, and 200,000 ppm NaCl) and hydrolyzed polyacrylamide solution concentrations (1000 and 2000 ppm), with and without chromium (III) presence. In each group, the left bar corresponds to 1000 ppm HPAM without resin, the next bar corresponds to 1000 ppm HPAM with resin, the next bar corresponds to 2000 ppm HPAM without resin, and the right bar corresponds to 2000 ppm HPAM with resin.

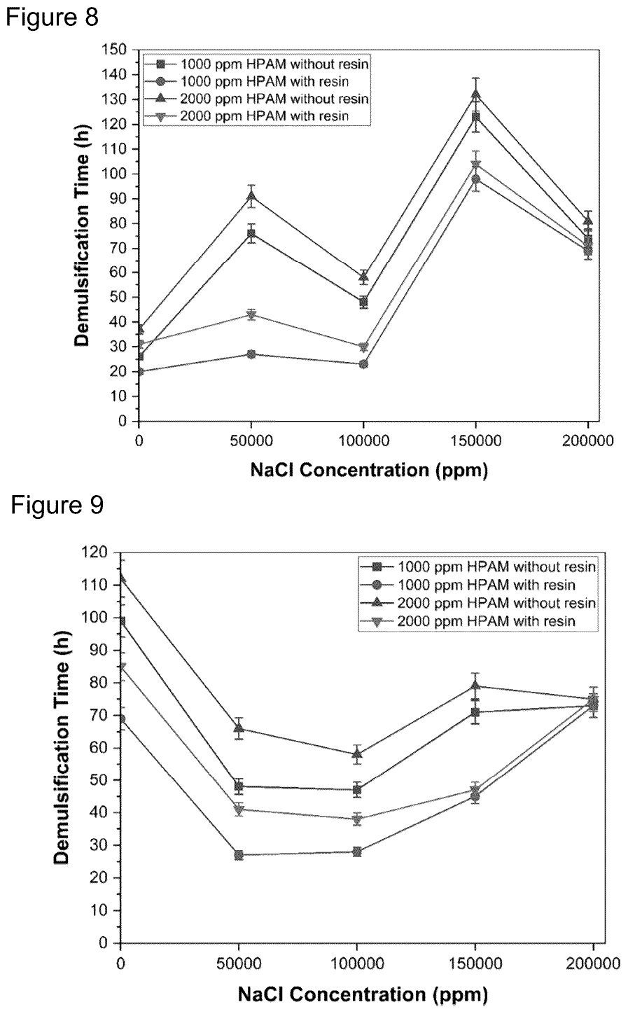

FIG. 8 is a graph giving the demulsification time as a function of NaCl concentration for samples containing 1000 and 2000 ppm HPAM aqueous solutions with and without chromium (III), and 400 ppm sodium lactate as retarder; illustrating the influence of salinity and HPAM concentration on demulsification efficiency.

FIG. 9 is a graph giving the demulsification time as a function of NaCl concentration for samples containing 1000 and 2000 ppm HPAM aqueous solutions with and without chromium (III), and 400 ppm sodium malonate as retarder; illustrating the influence of salinity and HPAM concentration on demulsification efficiency.

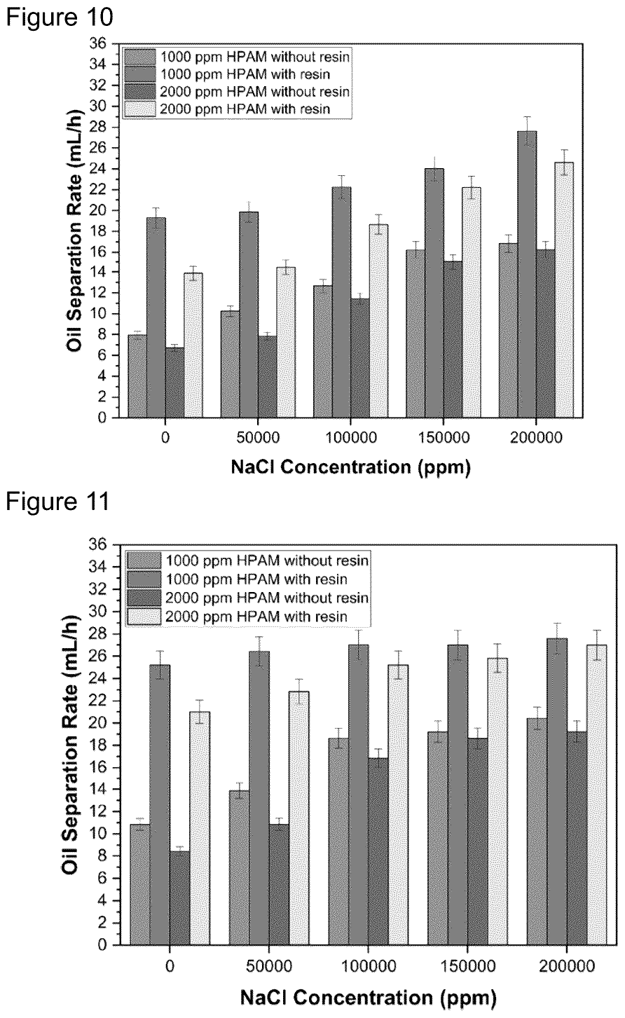

FIG. 10 is a graph giving the oil separation rates as a function of NaCl concentration (0-200,000 ppm) for samples with varying HPAM aqueous solution concentrations (1000 and 2000 ppm), using 400 ppm sodium lactate as retarder, and treatment conditions (presence or absence of chromium (III) ions and resin application for chromium removal). In each group, the left bar corresponds to 1000 ppm HPAM without resin, the next bar corresponds to 1000 ppm HPAM with resin, the next bar corresponds to 2000 ppm HPAM without resin, and the right bar corresponds to 2000 ppm HPAM with resin.

FIG. 11 is a graph giving the oil separation rates as a function of NaCl concentration (0-200,000 ppm) for samples with varying HPAM aqueous solution concentrations (1000 and 2000 ppm), using 400 ppm sodium malonate as retarder, and treatment conditions (presence or absence of chromium (III) ions and resin application for chromium removal). In each group, the left bar corresponds to 1000 ppm HPAM without resin, the next bar corresponds to 1000 ppm HPAM with resin, the next bar corresponds to 2000 ppm HPAM without resin, and the right bar corresponds to 2000 ppm HPAM with resin.

These experiments have explored the effects of chromium (III) ions, salinity, and retarders on the demulsification efficiency and oil separation rate of emulsions incorporating hydrolyzed polyacrylamide (HPAM) aqueous solutions, especially after gel degradation through sonication. The inventors identified a pronounced influence of chromium (III) ions on emulsion stability. The presence of chromium ions heightened demulsification durations, while their absence correspondingly reduced both emulsion stability and the time needed for demulsification.

Furthermore, salinity played a pivotal role in shaping demulsification efficiency and oil separation rate. Demulsification durations peaked at 150,000 ppm NaCl and reduced as salinity levels escalated further. The interplay between chromium (III) ions, salinity, and HPAM concentration significantly impacted the duration of demulsification.

The comparison of sodium lactate and sodium malonate as retarders demonstrates that the choice of retarder can considerably influence the demulsification process and oil separation rate. Sodium malonate, in particular, showcased a heightened enhancement in the oil separation rate under augmented salinity conditions in comparison to sodium lactate. Moreover, samples treated with resin for chromium removal exhibited higher oil separation rates, accentuating the vital role of chromium (III) ions in determining emulsion stability.

Experiments have explored the degradation of rigid gel particles in the presence of crude oil and introduces the use of retarders like Sodium Malonate and Sodium Lactate. These retarders serve to prolong the re-gelation process after the gel disintegrates into polymer and cross-linker. Moreover, the incorporation of cation-exchange resin with these retarders offers a distinctive approach in chromium removal. By harnessing the combined potential of sonication, resin treatment, and retarders, the findings suggest a promising avenue for confronting and potentially mitigating challenges faced in the oil and gas industry.

### Appendix: Gel Strength Test

The strength of the gel can be tested using a bottle test as described in Sydansk, Robert D. (“A new conformance-improvement-treatment chromium (III) gel technology.” SPE enhanced oil recovery symposium. OnePetro, SPE/DOE 17329, 1988.)

Bottle testing provides a measure of gelation rate and gel strength. Gel strength was assigned a letter code of A through J as defined by the gel-strength code in Table 1.

TABLE 1
Gel Strength Codes

| Code | Gel Type | Observable Features |
|---|---|---|
| A | No detectable gel | The gel appears to have the same viscosity (fluidity) as |
| | formed | the original polymer solution and no gel is visually |
| | | detectable. |
| B | Highly flowing gel | the gel appears to be only slightly more viscous (less |
| | | fluid) than the initial polymer solution |
| C | Flowing gel | most of the obviously detectable gel flows to the bottle |
| | | cap upon inversion. |
| D | Moderately flowing | only a small portion (about 5 to 15%) of the gel does not |
| | gel | readily flow to the bottle cap upon inversion usually |
| | | characterized as a “tonguing” gel (i.e., after hanging out |
| | | of jar, gel can be made to flow back into bottle by slowly |
| | | turning bottle upright). |
| E | Barely flowing gel | the gel can barely flow to the bottle cap and/or a |
| | | significant portion (>15%) of the gel does not flow upon |
| | | inversion |
| F | Highly deformable | gel does not flow to the bottle cap upon inversion. |
| | nonflowing gel | |
| G | Moderately | gel flows about halfway down the bottle upon inversion. |
| | deformable | |
| | nonflowing gel | |
| H | Slightly deformable | the gel surface only slightly deforms upon inversion. |
| | nonflowing gel | |
| I | Rigid gel | there is no gel-surface deformation upon inversion |
| J | Ringing rigid gel | a tuning-fork-like mechanical vibration can be felt after |
| | | tapping the bottle |

The gel-strength codes range from highly flowing gels with barely any gel structure visibly detectable to rigid rubbery gels. During testing, pre-gel solutions were simply formulated and placed in the bottle.

Then, gel strength was monitored as a function of time. Bottles were inverted during each reading; the gel's flow characteristics under the influence of gravity were noted; and a gel-strength code was assigned as defined in Table 1.

In the context of this disclosure, a gel can be more broadly categorized as a flowing gel (codes B-E), a nonflowing gel (codes F-H) or a rigid gel (codes I-J).

Sydansk found that the error in this test is within one letter (e.g., B vs. C code) for different observers.

All bottle-testing experiments carried out below 150° F. (66° C.) were performed in the same size bottle with the same gel volume. All such bottle-testing gel samples were of 50 cm³ volume and always placed in 4-ounce (120 cm³) wide-mouth bottles with an outside body diameter of 5.05 cm.

Although the present invention has been described and illustrated with respect to preferred embodiments and preferred uses thereof, it is not to be so limited since modifications and changes can be made therein which are within the full, intended scope of the invention as understood by those skilled in the art.

1. A method of removing gel from a mixture, the method comprising:
receiving an initial mixture in a degradation vessel, the initial mixture comprising a produced fluid including a polymer gel, oil and water, the produced fluid having been produced from an underground formation;
forming a degraded mixture by sonicating the initial mixture within the degradation vessel with ultrasonic waves, wherein the ultrasonic waves break crosslinking bonds of the polymer gel to generate a free polymer;
adding magnetic nanoparticles to the generated free polymer to form a magnetized mixture comprising agglomerated particles of magnetic nanoparticles bound to the free polymer; and
applying a magnetic field to the magnetized mixture to separate the agglomerated particles from other components of the magnetized mixture.

2. The method according to claim 1, wherein the viscosity of the polymer gel at 25° C. and 1 atm is at least 3,000 cps.

3. The method according to claim 1, wherein the polymer gel comprises at least one of a nonflowing gel and a rigid gel.

4. The method according to claim 1, wherein the magnetic nanoparticles comprise iron oxide.

5. The method according to claim 1, wherein the magnetic nanoparticles comprise one or more of magnetite (Fe₃O₄) and maghemite (γ-Fe₂O₃).

6. The method according to claim 1, wherein the magnetic nanoparticles are coated in a hydrophilic coating.

7. The method according to claim 1, wherein the magnetic nanoparticles are coated in a metallic oxide.

8. The method according to claim 1, wherein the magnetic nanoparticles are coated in one or more of: TiO₂, γ-Al₂O₃, MgO, ZrO₂ and NiO.

9. The method according to claim 1, wherein the ultrasonic waves generate bubbles within the gel-oil-water mixture via ultrasonic cavitation.

10. The method according to claim 1, wherein metal ions within the degraded mixture are deactivated using a retarder.

11. The method according to claim 1, wherein metal ions within the degraded mixture are deactivated using sodium lactate.

12. The method according to claim 1, wherein metal ions within the degraded mixture are removed using an ion exchange.

13. The method according to claim 1, wherein the method comprises adding salt to the initial mixture prior to the sonication.

14. The method according to claim 1, wherein the gel comprises hydrolyzed or partially hydrolyzed polyacrylamide.

15. The method according to claim 1, wherein the gel comprises a polymer crosslinked with metal ions.

16. The method according to claim 1, wherein the gel comprises a polymer crosslinked with chromium ions.

17. The method according to claim 1, wherein the agglomerated particles are detached into magnetic nanoparticle and free polymer by adjusting the pH of the agglomerated particles to unbind the magnetic nanoparticles from the free polymer, and applying a magnetic field to separate the unbound magnetic nanoparticles from the free polymer.

18. The method according to claim 1, wherein before the magnetic nanoparticles are added to the degraded mixture, the oil is separated from the degraded mixture using a crossflow separator.

19. The method according to claim 1, wherein the initial mixture is processed on a continuous basis.

20. The method according to claim 1, wherein the degradation vessel has an internal volume with a circular cross-section and walls which are free to vibrate.
